(19) United States
(12) Patent Application Publication
(10) Pub. No.: US 2013/0002079 A1
(43) Pub. Date: Jan. 3, 2013

(54) Motor

(75) Inventors: Sang Jin Park, Hwaseong (KR); Ta Kyoung Lee, Hwaseong (KR)

(73) Assignee: SAMSUNG ELECTRO-MECHANICS CO., LTD., Suwon (KR)

(21) Appl. No.: 13/373,390

(22) Filed: Nov. 14, 2011

(30) Foreign Application Priority Data
Jul. 1, 2011 (KR) 10-2011-0065453

(51) Int. Cl. H02K 1/27; H02K 21/22; H02K 1/28

(52) U.S. Cl. 310/156.12; 310/216.106; 310/156.21

(57) ABSTRACT

There is provided a motor including: a sleeve supporting a shaft; a hub operating together with the shaft and including a magnet; a base coupled to the sleeve and including a core having a coil wound therearound, the coil generating rotational driving force; and a magnetic flux increase space part formed to be enclosed between the magnet and the hub in order to increase magnetic flux density between the magnet and the core.

### CROSS-REFERENCE TO RELATED APPLICATIONS

This application claims the priority of Korean Patent Application No. 10-2011-0065453 filed on Jul. 1, 2011, in the Korean Intellectual Property Office, the disclosure of which is incorporated herein by reference.

### BACKGROUND OF THE INVENTION

1. Field of the Invention

The present invention relates to a motor, and more particularly, to a motor capable of being used in a hard disk drive (HDD) rotating a recording disk.

2. Description of the Related Art

A hard disk drive (HDD), an information storage device, reads data stored on a disk or writes data to the disk using a read/write head.

The hard disk drive requires a disk driving device capable of driving the disk. As the disk driving device, a small-sized spindle motor is used.

In the small-sized spindle motor, a fluid dynamic bearing has been used. The fluid dynamic bearing indicates a bearing in which a shaft, which is a rotating member, and a sleeve, which is a fixed member, have oil interposed therebetween, such that the shaft is supported by fluid pressure generated in the oil.

The hard disk drive (HDD) using this fluid dynamic bearing has been used in various portable products such as a netbook, a cellular phone, a portable multimedia player (PMP), a game machine, an MP3 player, and the like. Interest in the miniaturization and thinning of the hard disk drive has increased in consideration of the characteristics of portable products.

In addition, as cases in which users carry the hard disk drive (HDD) using the fluid dynamic bearing increase, whether or not noise and vibrations are generated in the spindle motor using the fluid dynamic bearing has become a significant issue.

Noise and vibrations may be generated by a shaking of a core or a magnetic flux of a magnet coupled to the rotating member.

In addition, since the spindle motor inevitably rotates at a high speed, the performance of the spindle motor depends on the rotational characteristics thereof.

These rotational characteristics are associated with the magnetic flux of the magnet, and a leakage magnetic flux caused in the magnetic flux of the magnet cannot act on the rotational characteristics of the spindle motor.

Therefore, research into technology for significantly reducing noise and vibrations, simultaneously with improving rotational characteristics by significantly reducing a leakage magnetic flux of a magnet in a spindle motor has been urgently demanded.

### SUMMARY OF THE INVENTION

An aspect of the present invention provides a motor capable of optimizing noise and vibration characteristics by adjusting a path of magnetic flux and a magnetic center simultaneously with improving efficiency by significantly reducing a leakage magnetic flux of a magnet.

According to an aspect of the present invention, there is provided a motor including: a sleeve supporting a shaft; a hub operating together with the shaft and including a magnet; a base coupled to the sleeve and including a core having a coil wound therearound, the coil generating rotational driving force; and a magnetic flux increase space part formed to be enclosed between the magnet and the hub in order to increase magnetic flux density between the magnet and the core.

The magnetic flux increase space part may be formed by a depression in at least one of facing surfaces of the magnet and the hub.

The magnet may have a magnetic center varied according to the magnetic flux increase space part.

The magnetic flux increase space part may have the same or different depths.

The magnetic flux increase space part may be filled with an adhesive to thereby increase adhesion between the magnet and the hub.

An upper surface of the magnet may be coupled to the hub, such that adhesion between the magnet and the hub is increased.

The hub may include a first cylindrical wall part coupled to the shaft, a disk part extended from an end portion of the first cylindrical wall part in an outer diameter direction, a second cylindrical wall part protruding downwardly from an end portion of the disk part in an axial direction, and a disk mounting part extended from an end portion of the second cylindrical wall part in the outer diameter direction, the magnet may be coupled to the second cylindrical wall part, and the magnetic flux increase space part may be formed between the magnet and the second cylindrical wall part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor according to an embodiment of the present invention;

FIG. 2 is a schematic cut-away perspective view showing a hub included in a motor according to an embodiment of the present invention;

FIG. 3 is a schematic cut-away perspective view showing a magnet included in a motor according to an embodiment of the present invention;

FIG. 4 is a schematic cut-away perspective view showing a modified example of a hub included in a motor according to an embodiment of the present invention; and

FIG. 5 is a schematic cut-away perspective view showing a modified example of a magnet included in a motor according to an embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, like reference numerals will be used to designate like components having similar functions throughout the drawings within the scope of the present invention.

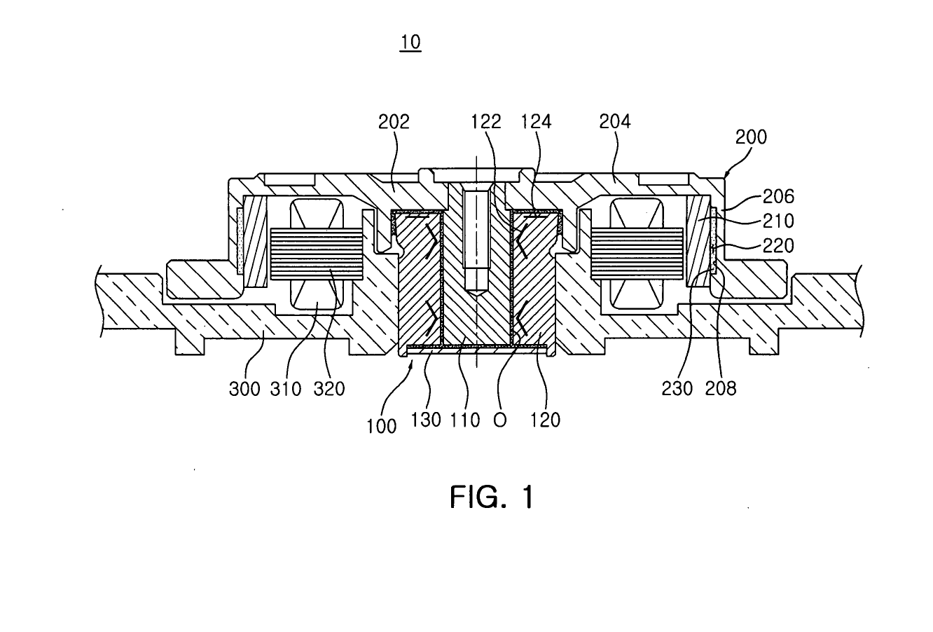

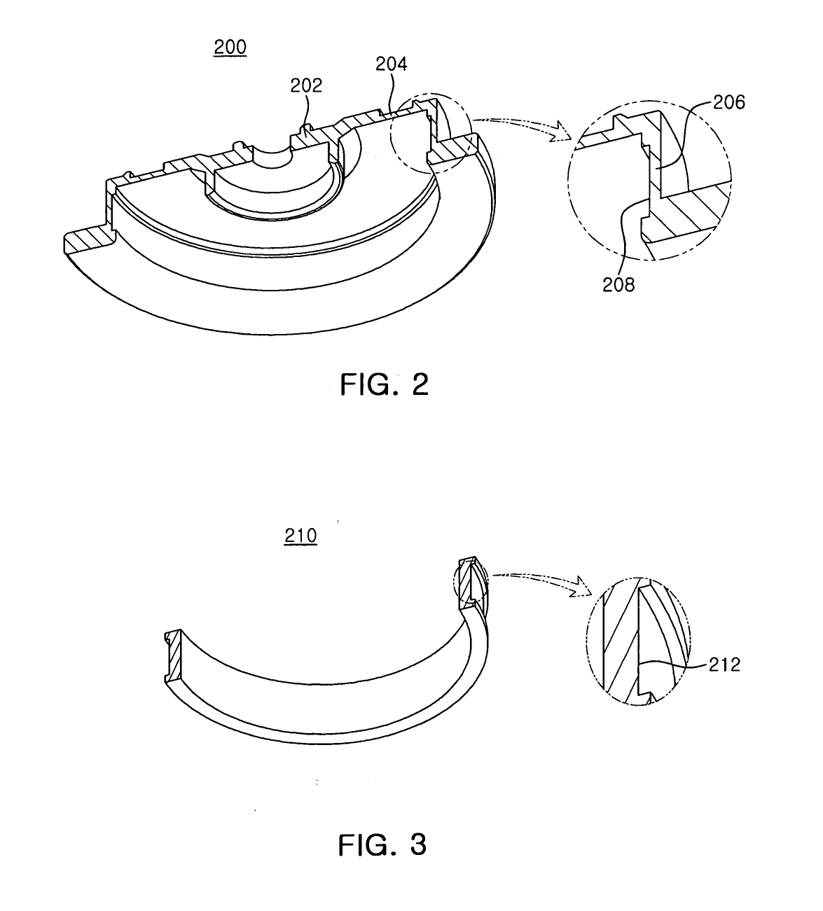

FIG. 1 is a schematic cross-sectional view showing a motor according to an embodiment of the present invention; FIG. 2 is a schematic cut-away perspective view showing a hub included in a motor according to an embodiment of the present invention;, and FIG. 3 is a schematic cut-away perspective view showing a magnet included in a motor according to an embodiment of the present invention.

Referring to FIGS. 1 and 2, a motor 10 according to an embodiment of the present invention may include a bearing assembly 100 including a fluid dynamic bearing, a hub 200 having a magnet 210 coupled thereto, a base 300 having a core 320 coupled thereto, the core 320 having a coil 310 wound therearound, and a magnetic flux increase space part 220.

Terms with respect to directions will first be defined. As viewed in FIG. 1, an axial direction refers to a vertical direction based on the shaft 110, and an outer diameter or inner diameter direction refers to a direction towards an outer edge of the hub 200 based on the shaft 110 or a direction towards the center of the shaft 110 based on the outer edge of the hub 200.

In addition, a circumferential direction refers to a rotation direction of the shaft 110, that is, a direction corresponding to an outer peripheral surface of the shaft 110.

The bearing assembly 100 may include the shaft 110, a sleeve 120, and a base cover 130.

The sleeve 120 may support the shaft 110 such that an upper end of the shaft 110 is provided to protrude upwardly in an axial direction, and may be formed by processing or powder-sintering a metal material such as Cu, an SUS-based alloy, or the like.

Here, the shaft 110 may be inserted into a shaft hole of the sleeve 120, having a micro clearance therewith. The micro clearance is filled with oil 0, and the rotation of the shaft 110 may be more stably supported by a fluid dynamic part 122 formed in at least one of an outer peripheral surface of the shaft 110 and an inner peripheral surface of the sleeve 120.

The fluid dynamic part 122 may configure a fluid dynamic bearing generating radial dynamic pressure in the oil O and may be formed at each of upper and lower portions of the sleeve 120 in order to more effectively support the shaft 110 by radial dynamic pressure.

However, the fluid dynamic part 122 may also be formed in the outer peripheral surface of the shaft 110 as well as in the inner peripheral surface of the sleeve 120 as described above. In addition, the number of the fluid dynamic parts is not limited.

Here, the fluid dynamic part 122 may be a groove having a herringbone shape, a spiral shape, or a helical (screw) shape. However, the fluid dynamic part 122 is not limited to having the above-mentioned shape but may also have any shape as long as radial dynamic pressure may be generated by the rotation of the shaft 110.

In addition, the sleeve 120 may have a thrust dynamic part 124 formed in an upper surface thereof, wherein the thrust dynamic part 124 generates thrust dynamic pressure through the oil. A rotating member including the shaft 110 may rotate in a state in which a predetermined floating force is secured by the thrust dynamic part 124.

Here, the thrust dynamic part 124 may be a groove having a herringbone shape, a spiral shape, or a helical shape, similar to the fluid dynamic part 122. However, the thrust dynamic part 124 is not limited to having the above-mentioned shape but may also have any shape as long as the thrust dynamic pressure may be provided.

In addition, the thrust dynamic part 124 is not limited to being formed in the upper surface of the sleeve 120 but may also be formed in one surface of the hub 200 corresponding to the upper surface of the sleeve 120.

The base cover 130 may maintain a clearance with the shaft 110 and the sleeve 120 to thereby provide a space filled with oil 0 and be coupled to the sleeve 120 to thereby seal a lower portion of the sleeve 120.

Here, the bearing assembly 100 according to the embodiment of the present invention may implement a full-fill structure in which only one side thereof is opened by the base cover 130. More specifically, in the bearing assembly 100, the clearance between the shaft 110 and the sleeve 120, the clearance between the shaft 110 and the base cover 130, and between the sleeve 120 and the hub 200 may be continually filled with the oil O.

The hub 200 may be a rotating structure rotatably provided with respect to a fixed member including the base 300.

In addition, the hub 200 may include an annular ring shaped magnet 210 provided on an inner peripheral surface thereof, wherein the annular ring shaped magnet 210 corresponds to the core 320, at a predetermined interval existing therebetween.

More specifically, the hub 200 may include a first cylindrical wall part 202 fixed to an upper end of the shaft 110, a disk part 204 extended from an end portion of the first cylindrical wall part 202 in an outer diameter direction, and a second cylindrical wall part 206 protruding downwardly from an end portion of the disk part 204, wherein the second cylindrical wall part 206 may have the magnet 210 coupled to an inner peripheral surface thereof.

Here, the magnet 210 and the second cylindrical wall part 206 of the hub 200 may include a magnetic flux increase space part 220 formed therebetween. The magnetic flux increase space part 220 will be described in detail below.

The base 300 may be a fixed member supporting the rotation of the rotating member including the shaft 110 and the hub 200.

Here, the base 300 may include the core 320 coupled thereto, wherein the core 320 has the coil 310 wound therearound. The core 320 may be fixedly disposed on an upper portion of the base 300 including a printed circuit board (not shown) having circuit patterns printed thereon.

In other words, an outer peripheral surface of the sleeve 120 and the core 320 having the coil 310 wound therearound may be inserted into the base 300, such that the sleeve 120 and the core 320 are coupled thereto.

Here, as a method of coupling the sleeve 120 and the core 320 to the base 300, a bonding method, a welding method, a press-fitting method, or the like, may be used. However, the method of coupling the sleeve 120 and the core 320 to the base 300 is not necessarily limited thereto.

The magnetic flux increase space part 220, which is a space formed between the magnet 210 and the hub 200, may be formed to be enclosed.

Since the magnetic flux increase space part 220 having the enclosed structure blocks an introduction of external air as compared to a case in which at least one side is opened, a generation of noise and vibrations due to air flow may be reduced.

More specifically, the magnetic flux increase space part 220, which is a component for increasing magnetic flux density between the magnet 210 and the core 320, may be formed by a depression in at least one of facing surfaces of the magnet 210 and the hub 200.

Although FIGS. 1 and 2 show only the magnetic flux increase space part 220 formed by the depression 208 in an inner surface of the second cylindrical wall part 206 of the hub 200, the present invention is not limited thereto. The magnetic flux increase space part 220 may also be formed by a depression 212 in an outer peripheral surface of the magnet 210 as shown in FIG. 3.

In other words, the magnetic flux increase space part 220 may be formed in at least one of the hub 200 and the magnet 210.

In addition, the magnetic flux increase space part 220 may be continuously or discontinuously formed, in a circumferential direction and have the same or different depths in a radial direction.

Here, a driving principle of the motor 10 according to the embodiment of the present invention will be described. When external power is applied to the coil 310 wound around the core 320, the hub 200 rotates by electromagnetic interaction between the coil 310 and the magnet 210 coupled to the hub 200.

Here, rotational driving force of the hub 200 is influenced by a path of a magnetic flux of the magnet 210 coupled to the hub 200. As an amount of magnetic flux flowing between the core 320 and the magnet 210 increases, rotational characteristics are improved.

Here, the hub 200 may be formed of a metal material to thereby have magnetism and may have a property of guiding the magnetic flux of the magnet 210. Therefore, in the magnetic flux of the magnet 210, a leakage magnetic flux, which is a magnetic flux flowing in an outer diameter direction due to the hub 200, increases.

That is, the magnet 210 has limited magnetic flux. However, when the magnetic flux flowing in the outer diameter direction increases due to the hub 200, a magnetic flux flowing in an inner diameter direction, that is, a magnetic flux flowing between the magnet 210 and the core 320 relatively decreases.

Therefore, the magnetic flux flowing between the magnet 210 and the core 320 decreases due to the hub 200, such that the rotational characteristics thereof are deteriorated.

However, the motor 10 according to the embodiment of the present invention may include the magnetic flux increase space part 220, which is a predetermined space, formed between the magnet 210 and the core 320, whereby leakage magnetic flux, which is the magnetic flux of the magnet 210 directed in the outer diameter direction, may be significantly reduced.

In other words, the magnetic flux increase space part 220 may lower the magnetic flux guiding property of the hub 200, whereby magnetic flux density between the magnet 210 and the core 320 may be improved.

Here, a length of the magnetic flux increase space part 220 in an axial direction or a depth thereof in a radial direction may be variously changed, and a magnetic center of the magnet 210 and a flow pattern of the magnetic flux may be changed.

That is, the magnetic center of the magnet 210 may be variable according to the magnetic flux increase space part 220, and when a height difference in an axial direction is generated in the relationship between the magnetic center of the magnet 210 and the center of the core 320, magnetic attractive force therebetween may be generated.

The magnetic attractive force as described above may indicate force acting on the rotating member including the shaft 110 and the hub 200 and directed upwardly or downwardly in the axial direction.

Therefore, when the force directed upwardly or downwardly in the axial direction is required in the rotating member according to designer' s intention, the height difference in the axial direction between the magnetic center of the magnet 210 and the center of the core 320 may be determined so as to be appropriate for the designer' s intention and the motor may be manufactured based on the determination.

However, the motor 10 according to the embodiment of the present invention may simply change the magnetic center of the magnet 210 by changing the length of the magnetic flux increase space part 220 in the axial direction or the depth thereof in the radial direction without changing a position of the magnet 210, whereby a magnitude and a direction of the magnetic attractive force may be changed according to a situation.

In addition, since the flow pattern of the magnetic flux of the magnet 210 may be changed by changing the length of the magnetic flux increase space part 220 in the axial direction or the depth thereof in the radial direction, a magnitude of rotational driving force due to electromagnetic interaction between the magnet 210 and the coil 310 may also be adjusted.

Furthermore, noise and vibration characteristics may be optimized due to the decrease in the leakage magnetic flux, which is the magnetic flux of the magnet 210 directed in the outer diameter direction, and the adjustment of the flow pattern of the magnetic flux.

Additionally, the magnetic flux increase space part 220 may be filled with an adhesive 230 to thereby increase adhesion between the magnet 210 and the hub 200. The magnetic flux increase space part 220 may also include a non-magnetic material filled therein, instead of the adhesive 230.

In addition, an upper surface of the magnet 210 is coupled to the hub 200, such that adhesion between the magnet 210 and the hub 200 may be increased, and upper and lower portions of the magnet 210 are coupled to an inner peripheral surface of the second cylindrical wall part 206 of the hub 200, such that coupling force may be improved.

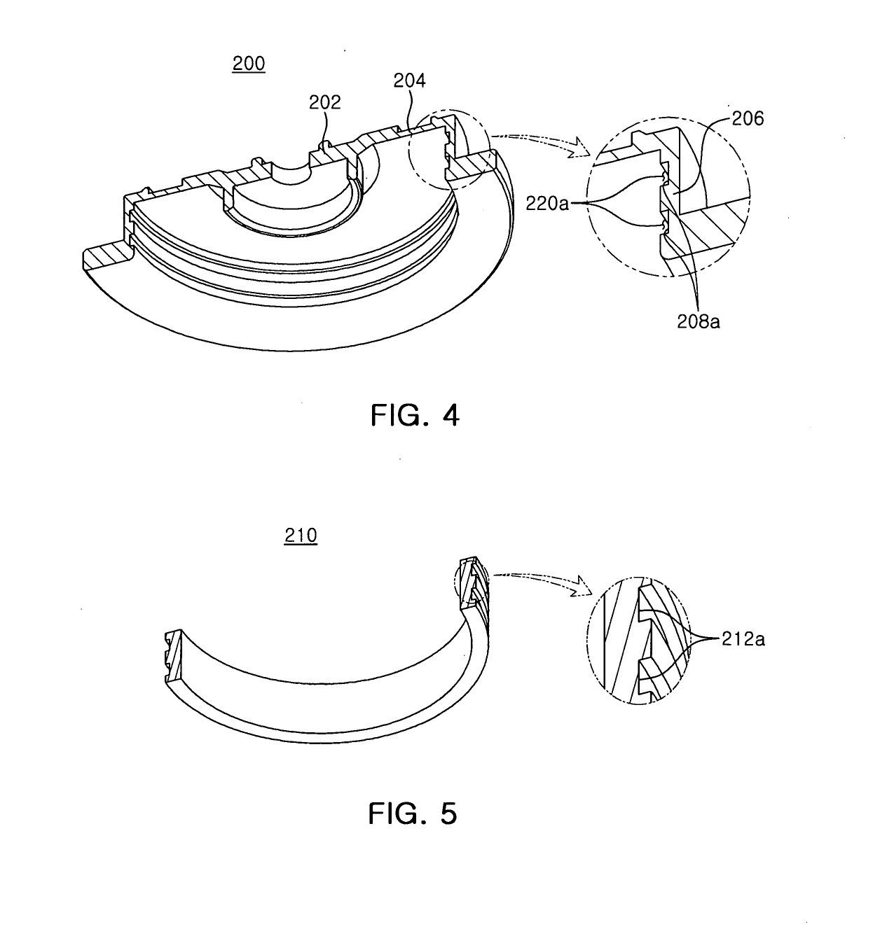

FIG. 4 is a schematic cut-away perspective view showing a modified example of a hub included in a motor according to an embodiment of the present invention; and FIG. 5 is a schematic cut-away perspective view showing a modified example of a magnet included in a motor according to an embodiment of the present invention.

Referring to FIGS. 4 and 5, a magnetic flux increase space part 220a may have the same configuration and effect as those of the magnetic flux increase space part 220 described with reference to FIGS. 1 through 3, except that the magnetic flux increase space part 220a is formed in plural so the parts thereof are spaced apart from each other in an axial direction.

Therefore, the magnetic flux increase space part 220a may have a structure in which upper and lower portions thereof in an axial direction are sealed and isolated and formed to be entirely enclosed.

In addition, the magnetic flux increase space part 220a may be formed by a depression 208a in an inner peripheral surface of the second cylindrical wall part 206 of the hub 200 as shown in FIG. 4 or be formed by a depression 212a in an outer peripheral surface of the magnet 210 as shown in FIG. 5.

Furthermore, the magnetic flux increase space part 220a may also be simultaneously provided in the inner peripheral surface of the second cylindrical wall part 206 of the hub 200 and the outer peripheral surface of the magnet 210.

In addition, the magnetic flux increase space part 220a may be filled with an adhesive 230 in order to increase adhesion between the magnet 210 and the hub 200.

In addition, the magnetic flux increase space part 220a may be continuously or discontinuously formed in a circumferential direction and have the same or different depths in a radial direction.

Here, although FIGS. 4 and 5 show that the magnetic flux increase space part 220a is formed in two parts, the present invention is not limited thereto but may be variously changed according to designer's intention.

Through the above-mentioned embodiments, due to the magnetic flux increase space part 220 or 220a formed between the magnet 210 and the hub 200, the leakage magnetic flux of the magnet 210 may be signifincatly reduced, and the rotational characteristics of the motor 10 according to the present invention may be improved.

In addition, the path of the magnetic flux and the magnetic center of the magnet 210 are adjusted, whereby noise and vibration characteristics may be optimized.

As set forth above, with the motor according to the embodiment of the present invention, the leakage magnetic flux of the magnet is significantly reduced, whereby rotational characteristics of the motor may be improved while the motor is miniaturized and thinned.

In addition, the path of the magnetic flux and the magnetic center of the magnet are adjusted, whereby noise and vibration characteristics may be optimized.

While the present invention has been shown and described in connection with the embodiments, it will be apparent to those skilled in the art that modifications and variations can be made without departing from the spirit and scope of the invention as defined by the appended claims.

What is claimed is:

1. A motor comprising:
a sleeve supporting a shaft;
a hub operating together with the shaft and including a magnet;
a base coupled to the sleeve and including a core having a coil wound therearound, the coil generating rotational driving force; and
a magnetic flux increase space part formed to be enclosed between the magnet and the hub in order to increase magnetic flux density between the magnet and the core.

2. The motor of claim 1, wherein the magnetic flux increase space part is formed by a depression in at least one of facing surfaces of the magnet and the hub.

3. The motor of claim 1, wherein the magnet has a magnetic center varied according to the magnetic flux increase space part.

4. The motor of claim 1, wherein the magnetic flux increase space part has the same or different depths.

5. The motor of claim 1, wherein the magnetic flux increase space part is filled with an adhesive to thereby increase adhesion between the magnet and the hub.

6. The motor of claim 1, wherein an upper surface of the magnet is coupled to the hub, such that adhesion between the magnet and the hub is increased.

7. The motor of claim 1, wherein the hub includes a first cylindrical wall part coupled to the shaft, a disk part extended from an end portion of the first cylindrical wall part in an outer diameter direction, a second cylindrical wall part protruding downwardly from an end portion of the disk part in an axial direction, and a disk mounting part extended from an end portion of the second cylindrical wall part in the outer diameter direction, and
wherein the magnet is coupled to the second cylindrical wall part, and the magnetic flux increase space part is formed between the magnet and the second cylindrical wall part.
